(19) United States
(12) Patent Application Publication
(10) Pub. No.: US 2021/0338498 A1
(43) Pub. Date: Nov. 4, 2021

(54) BODY SUPPORT BOARD FOR FLOOR AND ASSOCIATED METHODS

(71) Applicant: Daniel M. Schwab, Anchorage, AK (US)

(72) Inventor: Daniel M. Schwab, Anchorage, AK (US)

(21) Appl. No.: 17/308,013

(22) Filed: May 4, 2021

Related U.S. Application Data
(60) Provisional application No. 63/019,487, filed on May 4, 2020.

(51) Int. Cl. A61G 1/056

(52) U.S. Cl. CPC A61G 1/056

(57) ABSTRACT

The present invention is a body support board for floor and associated methods, and is configured to be placed on a floor surface or other planar surface and support a user or worker who has to perform certain tasks in confined spaces and/or underneath certain structures or to perform certain tasks lying on their back or stomach, thereon. The body support board provides a comfortable work surface for a user to lay on while working. In a non-limiting exemplary embodiment, the body support board preferably includes an elongated board member, padded section(s), a head cushion, at least one light member, at least one removeable tool case, at least one light switch, and an adjustable support leg or stand. Preferably, the body support board also includes an S-shape profile or configuration. The S-shape profile or configuration allows a user or worker to more easily reach up to a work area.

### CROSS-REFERENCE TO RELATED APPLICATIONS

The present application claims the priority benefit of U.S. Provisional Patent Application Ser. No. 63/019,487, filed on May 4, 2020 and titled “Body Support Board for Floor and Associated Methods,” which is incorporated herein by reference in its entirety.

### BACKGROUND OF THE INVENTION

### Field of the Invention

The present invention generally relates to body support boards, devices, and apparatuses for supporting the body of a user or worker, such as mechanics, plumbers, and the like, who has to perform certain tasks underneath certain structures or certain tasks lying on their back or stomach. More specifically, the present invention is a body support board for floor and associated methods.

### Description of the Related Art

Body support boards, devices, and apparatuses for supporting the body of a user or worker who has to perform certain tasks underneath certain structures or certain tasks lying on their back or stomach are known in the art.

Mechanics or other people who work in a confined space along a floor, such as under a vehicle, often have a need to be supported above the floor yet move along the floor to accomplish their work. Various other tasks may require a work-surface for placing along a floor surface for additional comfort while performing these tasks. It is known in the art to utilize a creeper to perform these functions. Prior art creepers support the user in a prone position and typically include multiple casters positioned around the periphery of the creeper body to enable both translational and rotational movement of the creeper. However, these devices may be uncomfortable and do not feature ergonomic, adjustable configurations. A suitable solution is desired.

Accordingly, a need remains for user or worker support devices having adjustable features in order to overcome at least one of the above-noted shortcomings. The exemplary embodiment(s) of the present invention satisfy such a need by providing an adjustable user or worker support device for placement on a floor surface that is convenient and easy to use, lightweight yet durable in design, versatile in its applications, and designed to provide a comfortable work surface for supporting a user or worker while working in confined spaces including under a vehicle, under a sink, or the like.

The Applicant is unaware of inventions or patent documents, taken either singly or in combination, which are seen to describe the present invention as claimed.

One advantage of the body support board of the present invention is that it may be made or manufactured of a lightweight material.

Another advantage of the body support board of the present invention is that it may include head and/or back supports or paddings.

A further advantage of the body support board of the present invention is that it may include lights near the head area or end.

An additional advantage of the body support board of the present invention is that it may include an adjustable support leg or stand to provide a height adjusting feature.

Another advantage of the body support board of the present invention is that its S-shape profile or configuration may be able to support the spine and back of a user or worker in an ergonomic way.

### SUMMARY OF THE INVENTION

The present invention is a body support board for floor and associated methods. The body support board is configured to be placed on a floor surface or other planar surface and support a user or worker, such as mechanics, plumbers, and the like, who has to perform certain tasks in confined spaces and/or underneath certain structures, such as, but not limited to, under a vehicle or under a sink, or to perform certain tasks lying on their back or stomach, thereon. The body support board provides a comfortable work surface for a user to lay on while working.

In a non-limiting exemplary embodiment, the body support board preferably comprises an elongated board member, padded section(s), a head cushion, at least one light member, at least one removeable or detachable tool case, at least one light switch, and an adjustable support leg or stand. Preferably, the body support board also comprises an S-shape profile or configuration. The S-shape profile or configuration allows a user or worker to more easily reach up to a work area.

### BRIEF DESCRIPTION OF THE DRAWINGS

FIG. 1 a perspective, left side view of a body support board according to the present invention;

FIG. 2 is a front view of the body support board of FIG. 1, wherein an adjustable support leg or stand is in an extended position;

FIG. 3 is a rear view of the body support board of FIG. 1, wherein an adjustable support leg or stand is in an extended position;

FIG. 4 is a right side view of the body support board of FIG. 1, wherein an adjustable support leg or stand is in an extended position;

FIG. 5 is a left side view of the body support board of FIG. 1, wherein an adjustable support leg or stand is in an extended position;

FIG. 6 is a top view of the body support board of FIG. 1; and

FIG. 7 is a bottom view of the body support board of FIG. 1, wherein an adjustable support leg or stand is in a folded position.

It should be understood that the above-attached figures are not intended to limit the scope of the present invention in any way.

### DETAILED DESCRIPTION OF THE EMBODIMENTS OF THE PRESENT INVENTION

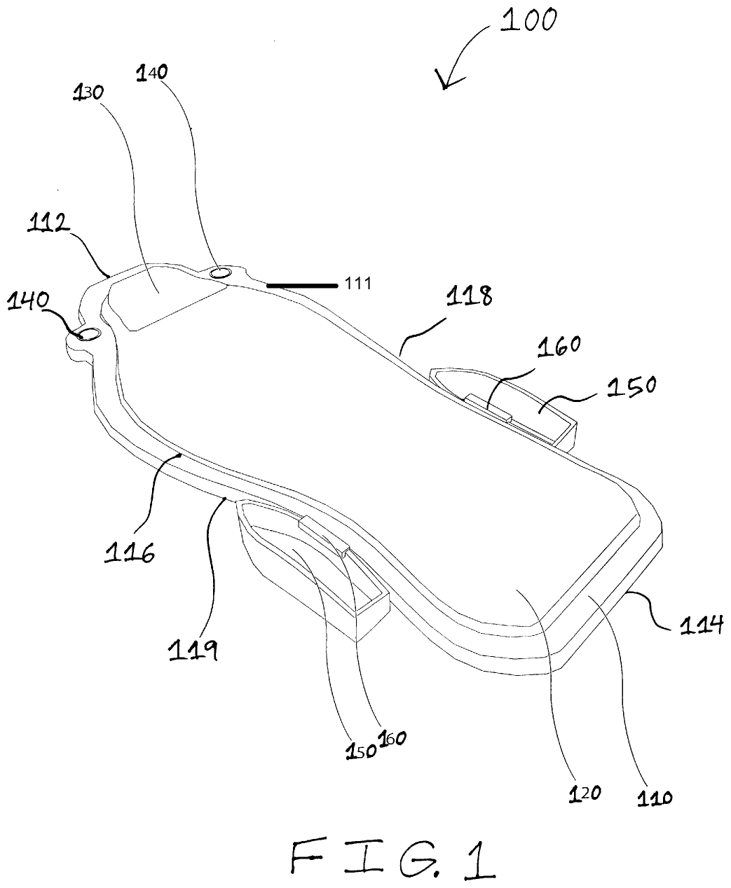

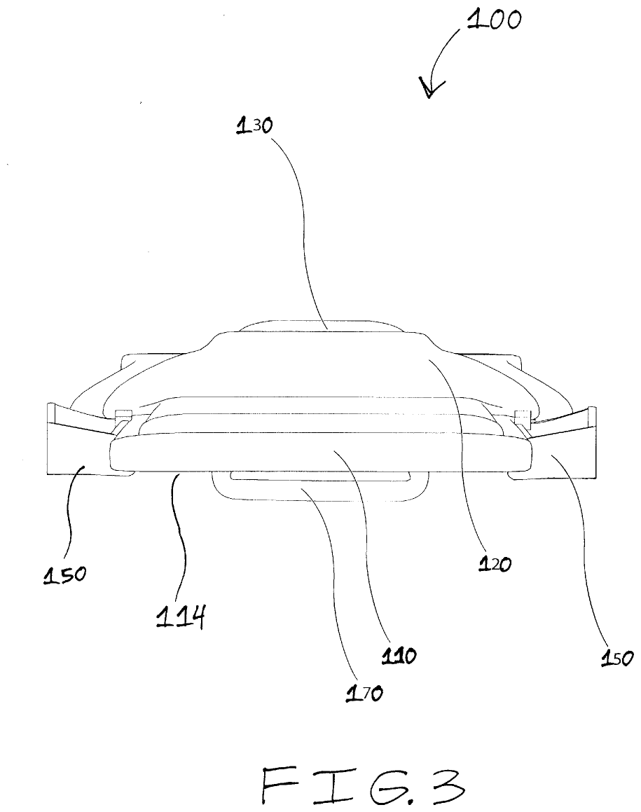

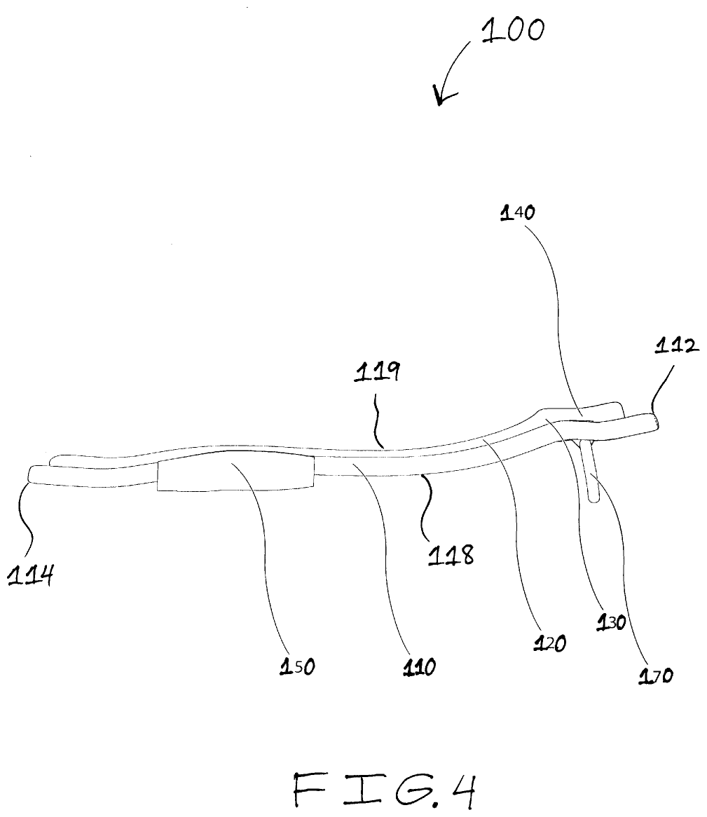

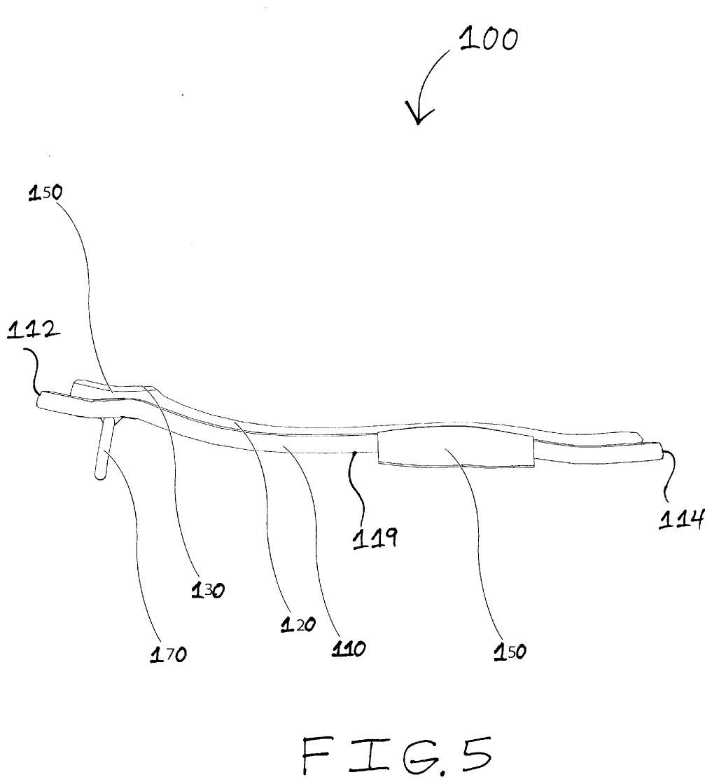

Referring to FIGS. 1-7, the present invention is a body support board 100 for floor and associated methods. The body support board 100 is configured to be placed on a floor surface or other planar surface and support a user or worker, such as mechanics, plumbers, and the like, who has to perform certain tasks in confined spaces and/or underneath certain structures, such as, but not limited to, under a vehicle or under a sink, or to perform certain tasks lying on their back or stomach, thereon. The body support board 100 provides a comfortable work surface for a user to lay on while working.

The non-limiting exemplary embodiment(s) will now be described more fully hereinafter with reference to the accompanying drawings, in which a preferred embodiment of the disclosure is shown. Such exemplary embodiment(s) may, however, be embodied in many different forms and should not be construed as limited to the embodiment set forth herein. Rather, these embodiment(s) are provided so that this application will be thorough and complete, and will fully convey the true scope of the disclosure to those skilled in the art.

The below disclosed subject matter is to be considered illustrative, and not restrictive, and any appended claim(s) are intended to cover all such modifications, enhancements, and other embodiment(s) which fall within the true scope of the non-limiting exemplary embodiment(s). Thus, to the maximum extent allowed by law, the scope of the non-limiting exemplary embodiment(s) is to be determined by the broadest permissible interpretation of the claim(s) and their equivalents, and shall not be restricted or limited by the foregoing detailed description.

References in the specification to “an exemplary embodiment”, “an embodiment”, “a preferred embodiment”, “an alternative embodiment” and similar phrases mean that a particular feature, structure, or characteristic described in connection with the embodiment(s) is included in at least an embodiment of the disclosure. The appearances of the phrase “a non-limiting exemplary embodiment” in various places in the specification are not necessarily all meant to refer to the same embodiment.

A non-limiting exemplary embodiment(s) of the present disclosure is referred to generally in the figures and is intended to provide a height-adjustable, body support board for placing on a floor surface. It should be understood that the exemplary embodiment(s) may be used to support a spine and back of a user or worker while working in a confined space, such as, but not limited to, under a vehicle or under a sink, and should not be limited to any particular body support board described herein.

Referring to FIGS. 1-7 in general, in a non-limiting exemplary embodiment, the body support board 100 preferably comprises an elongated board member 110, padded section(s) 120, a head cushion 130, at least one light member 140, at least one removeable or detachable tool case 150, at least one light switch 160, and an adjustable support leg or stand 170. Preferably, the body support board 100 also comprises an S-shape profile or configuration for providing spine and back support for a user or worker. The S-shape profile or configuration allows a user or worker to more easily reach up to a work area.

As best shown in FIGS. 1 and 6-7, the elongated board member 110 comprises a first end 112, a second end 114, a body 116, a first or right side 118, and a second or left side 119. The body 116 extends from the first end 112 to the second end 114. The elongated board member 110 is preferably made or manufactured of a strong and durable material that can withstand users of different sizes and/or weights. Preferably, the elongated board member 110 is made or manufactured of a plastic material, a metal material, aluminum, a wood material, and any combination thereof. More preferably, the elongated board member 110 is made or manufactured of a plastic material, such as, but not limited to, a strong plastic material or a hard plastic material. Preferably, the elongated board member 110 is made or manufactured of a lightweight material.

As best shown in FIGS. 1, 2-3 and 6, the padded section(s) 120 is positioned on top of the top surface 111 of the elongated board member 110, and preferably extends for most of the length and width of the elongated board member 110. Preferably, the padded section(s) 120 has a sufficient thickness to provide sufficient comfort and/or support to the user or worker laying on the padded section(s) 120. Preferably, the padded section(s) 120 is made or manufactured of a foam material (such as, but not limited to, a soft foam material), a rubber material, any padded or supportive material known to one of ordinary skill in the art, or any combination thereof. Preferably, the padded section(s) 120 is made or manufactured of a material that has sufficient resiliency to be durable.

As best shown in FIGS. 1-3 and 6, the head cushion 130 is positioned or located at or about the first end 112 of the elongated board member 110. Preferably, the head cushion 130 has a sufficient thickness to provide sufficient comfort and/or support to the user's or worker's head laying on the head cushion 130. Preferably, the head cushion 130 has a thickness that is greater than the thickness of the padded section(s) 120. Preferably, the head cushion 130 is made or manufactured of a foam material (such as, but not limited to, a soft foam material), a rubber material, any padded or supportive material known to one of ordinary skill in the art, or any combination thereof. Preferably, the head cushion 130 is made or manufactured of a material that has sufficient resiliency to be durable.

As best shown in FIGS. 1-2 and 6, the at least one light member 140 is preferably a pair of light members 140 that are positioned on opposing sides of the head cushion 130. Each of the pair of light members 140 provides illumination to assist a user or worker while working. The light members 140 may be battery powered halogen lights, other suitable light members known to one of ordinary skill in the art, or any combination thereof. As a non-limiting example, the light members 140 may be adjustable to different heights and/or angles, such as, but not limited to, zero degree to one hundred eighty degrees, for allowing a user or worker to aim each light member 140 at a targeted area for illumination of a work area.

As best shown in FIGS. 1 and 4-7, the at least one removeable or detachable tool case 150 is preferably a pair of removeable or detachable tool case 150 that are preferably positioned at corresponding sides or side portions 118,119 of the elongated board member 110. Each of the removeable or detachable tool cases 150 is dimensioned and configured to receive and retain at least one tool, such as, but not limited to, a wrench a plier, a screwdriver, or a hammer.

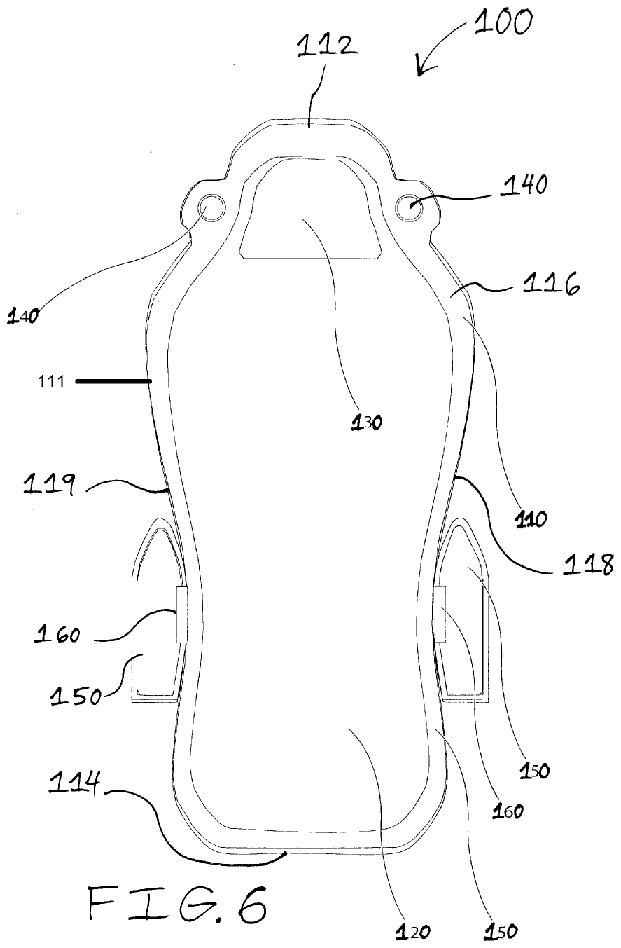

As best shown in FIGS. 1 and 6, the at least one light switch 160 is preferably a pair of light switches 160 that are preferably positioned at the corresponding sides or side portions 118,119 of the elongated board member 110. More preferably, each of the pair of light switches 160 is proximal to the corresponding removeable or detachable tool case 150 for user or worker easier accessibility to the desired tool(s) located in the tool case 150.

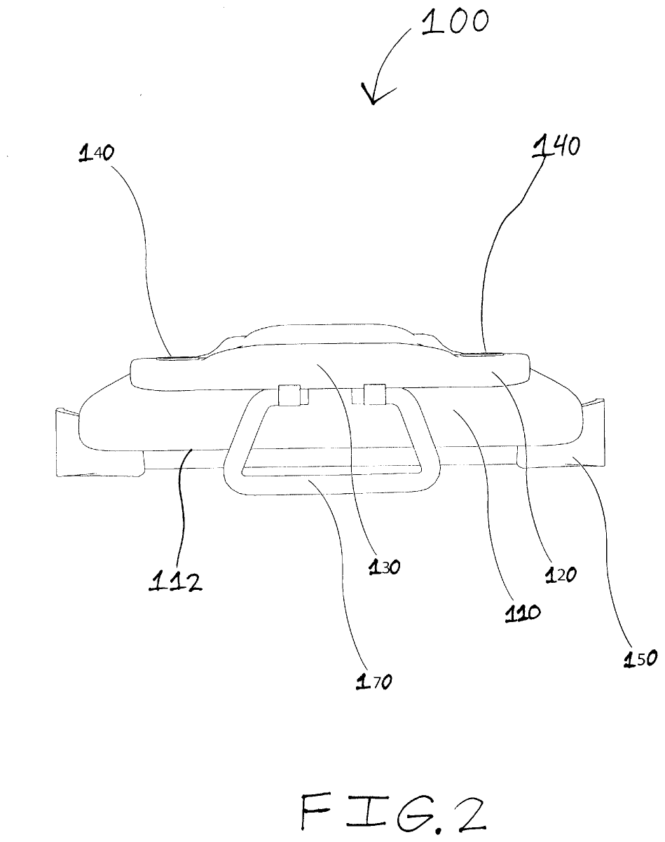

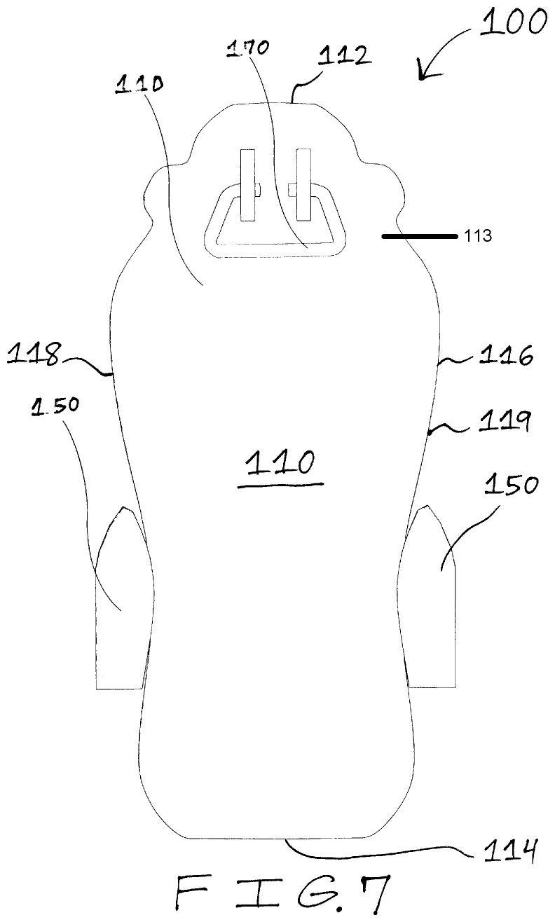

As best shown in FIGS. 2-5 and 7, the adjustable support leg or stand 170 is capable of being extended downward (from a folded position in FIG. 7 to an extended position(s) in FIGS. 2-5) from a bottom surface 113 of the elongated board member 110, and is preferably positioned underneath the head area or area or location of the head cushion 130. Alternatively, the adjustable support leg or stand 170 may be positioned on the sides 118,119, or anywhere else, of the elongated board member 110 or other component that produces similar height adjustment effects. The adjustable support leg or stand 170 provides means for controlling and adjusting a height at which the elongated board member 110 is supported. The adjustable support leg or stand 170 may be pivotable in relation to the bottom surface 113 of the elongated board member 110. The adjustable support leg or stand 170 is dimensioned and configured to fully extend into an unfolded position (shown in FIG. 7) to support the elongated board member 110 at a higher position from the floor or ground surface. Alternatively, the adjustable support leg or stand 170 may be positioned at any angle between the fully extended (shown in FIGS. 2-5), unfolded position and a folded position (shown in FIG. 7) in order to support the elongated board member 110 at a desired height relative to the floor or ground surface. The adjustable support leg or stand 170 is preferably made or manufactured of a strong and durable material that can withstand users of different sizes and/or weights. Preferably, the adjustable support leg or stand 170 is made or manufactured of a plastic material, a metal material, aluminum, a wood material, and any combination thereof. Preferably, the adjustable support leg or stand 170 is made or manufactured of a lightweight material.

Preferably, many, most or all of the components, especially the elongated board member 110, of the body support board 100 is made or manufactured of a plastic material, a metal material, aluminum, a wood material, and any combination thereof. More preferably, many, most or all of the components, especially the elongated board member 110, of the body support board 100 is made or manufactured of a plastic material. Preferably, many, most or all of the components, especially the elongated board member 110, of the body support board 100 is made or manufactured of a lightweight material.

It is to be understood that the present invention is not limited to the embodiments and non-limiting examples described above or as shown in the attached figures, but encompasses any and all embodiments within the spirit of the invention.

1. A body support board comprising:
an elongated board member dimensioned and configured to be supported on a planar surface and to receive and provide a work surface for a user positioned thereon,
wherein said elongated board member comprises a first end, a second end, a body, a first side, a second side, a top surface, and a bottom surface, and
wherein said body extends from said first end to said second end;
at least one padded section positioned upon said top surface of said elongated board member,
wherein at least one padded section is dimensioned and configured for providing body support to the user when the user is positioned thereon; and
an S-shape profile or configuration.

2. The body support board according to claim 1, wherein said at least one padded section is positioned upon a section of said top surface whereupon a back body portion of the user is capable of receiving back body support when the user is positioned thereon.

3. The body support board according to claim 1, wherein said at least one padded section is positioned upon a section of said top surface whereupon a head portion of the user is capable of receiving head support when the user is positioned thereon.

4. The body support board according to claim 1, further comprising at least one light member for illuminating a sufficient area of a surrounding area for the user to view.

5. The body support board according to claim 1, further comprising at least one removeable or detachable tool case dimensioned and configured for receiving and retaining at least one tool.

6. The body support board according to claim 5, further comprising at least one light switch for illuminating a sufficient area about said at least one removeable or detachable tool case for the user to view the at least one tool.

7. The body support board according to claim 1, further comprising an adjustable support leg or stand.

8. A body support board comprising:
an elongated board member dimensioned and configured to be supported on a planar surface and to receive and provide a work surface for a user positioned thereon,
wherein said elongated board member comprises a first end, a second end, a body, a first side, a second side, a top surface, and a bottom surface, and
wherein said body extends from said first end to said second end;
at least one padded section positioned upon said top surface of said elongated board member,
wherein at least one padded section is dimensioned and configured for providing body support to the user when the user is positioned thereon; and
an adjustable support leg or stand dimensioned and configured for adjusting from a first height to at least one other height at which said elongated board member is supported.

9. The body support board according to claim 8, wherein said at least one padded section is positioned upon a section of said top surface whereupon a back body portion of the user is capable of receiving back body support when the user is positioned thereon.

10. The body support board according to claim 8, wherein said at least one padded section is positioned upon a section of said top surface whereupon a head portion of the user is capable of receiving head support when the user is positioned thereon.

11. The body support board according to claim 8, further comprising at least one light member for illuminating a sufficient area of a surrounding area for the user to view.

12. The body support board according to claim 8, further comprising at least one removeable or detachable tool case dimensioned and configured for receiving and retaining at least one tool.

13. The body support board according to claim 12, further comprising at least one light switch for illuminating a sufficient area about said at least one removeable or detachable tool case for the user to view the at least one tool.

14. A body support board for floor and associated methods and tasks, said body support board comprising:
an elongated board member dimensioned and configured to be supported on a planar surface and to receive and provide a work surface for a user positioned thereon,
wherein said elongated board member comprises a first end, a second end, a body, a first side, a second side, a top surface, and a bottom surface, and
wherein said body extends from said first end to said second end; and
a plurality of padded sections positioned upon said top surface of said elongated board member,
wherein at least one padded section of said plurality of padded sections is positioned upon a section of said top surface whereupon a back body portion of the user is capable of receiving back body support when the user is positioned thereon, and
wherein at least one padded section of said plurality of padded sections is positioned upon a section of said top surface whereupon a head portion of the user is capable of receiving head support when the user is positioned thereon.

15. The body support board according to claim 14, further comprising an S-shape profile or configuration.

16. The body support board according to claim 14, further comprising at least one light member for illuminating a sufficient area of a surrounding area for the user to view.

17. The body support board according to claim 14, further comprising at least one removeable or detachable tool case dimensioned and configured for receiving and retaining at least one tool.

18. The body support board according to claim 17, further comprising at least one light switch for illuminating a sufficient area about said at least one removeable or detachable tool case for the user to view the at least one tool.

19. The body support board according to claim 14, further comprising an adjustable support leg or stand.

20. The body support board according to claim 14, further comprising an S-shape profile or configuration, at least one light member, at least one removeable or detachable tool case, at least one light switch, and an adjustable support leg or stand, wherein said at least one light member is capable of illuminating a sufficient area of a surrounding area for the user to view, wherein said at least one removeable or detachable tool case is dimensioned and configured for receiving and retaining at least one tool and wherein said at least one light switch is capable of illuminating a sufficient area about said at least one removeable or detachable tool case for the user to view the at least one tool.
